(19) United States
(12) Patent Application Publication
(10) Pub. No.: US 2015/0158407 A1
(43) Pub. Date: Jun. 11, 2015

(54) HEAT RADIATOR FOR CUP HOLDER AND CUP HOLDER USING THE SAME

(71) Applicant: Hyundai Motor Company, Seoul (KR)

(72) Inventors: Man Ju OH, Yongin-si (KR); Jae Woong KIM, Hwaseong-si (KR); Jae Woo PARK, Ansan-si (KR); Jae Hoon KIM, Cheonan-si (KR)

(73) Assignee: Hyundai Motor Company, Seoul (KR)

(21) Appl. No.: 14/461,158

(22) Filed: Aug. 15, 2014

(30) Foreign Application Priority Data
Dec. 6, 2013 (KR) 10-2013-0151889

(51) Int. Cl. B60N 3/10; A47G 19/22

(52) U.S. Cl. CPC B60N 3/104; A47G 19/2288

(57) ABSTRACT

A heat radiator for a cup holder may include a heat pipe with an one end fixed in a surface contact with a heat radiation side of a thermoelectric element mounted on a body of the cup holder and another end being extended from the one end at least above the one end, heat radiation fins fixed in a surface contact with another end of the heat pipe, and a blower engaged to the another end of the heat pipe so as to enable the heat radiation fins to exchange heat.

### CROSS-REFERENCE TO RELATED APPLICATION

The present application claims priority to Korean Patent Application No. 10-2013-0151889 filed Dec. 6, 2013, the entire contents of which is incorporated herein for all purposes by this reference.

### BACKGROUND

1. Field of the Invention

The present invention relates to a heat radiator for the cup holder which can reduce weight and volume and the cup holder using the same.

2. Description of Related Art

The thickness of the base was necessary in the structure radiating heat through the heat radiation sides of the existing thermoelectric elements, because the areas of the thermoelectric elements are small and the heat radiation areas are large.

When the thickness is small, heat of the heat radiation sides of thermoelectric elements is not radiated, and thus thermal efficiency considerably drops. Further, when the thickness of the base increases, the weight of the heat sink significantly increases and the cost of the material also increases.

In order to bring a heat pipe in contact with a thermoelectric element, the base of a heat radiation part is necessary and the heat pipe should be inserted in the base. This makes it difficult to reduce the thickness of the base and increases the weight and the cost. A weight structure is required to use bar type heat pipes, but it is heavy and the contact surface acts as a thermal resistance, thereby reducing heat radiation efficiency.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a heat radiator for the cup holder which can reduce weight and volume and the cup holder using the heat radiator.

In an aspect of the present invention, a heat radiator for a cup holder may include a heat pipe with an one end fixed in a surface contact with a heat radiation side of a thermoelectric element mounted on a body of the cup holder and another end being extended from the one end at least above the one end, heat radiation fins fixed in a surface contact with another end of the heat pipe, and a blower engaged to the another end of the heat pipe so as to enable the heat radiation fins to exchange heat.

The heat pipe and the heat radiation fins are coupled by soldering or heat conduction bonding.

The heat pipe is in a shape of a plate and is closed under a vacuum state with a plurality of channels horizontally arranged in parallel therein.

The heat radiation fins are coupled to the heat pipe to be aligned in a direction of the channels of the heat pipe.

An one end of the heat pipe is formed wider than the thermoelectric element and may include an inner channel section being in direct contact with the thermoelectric element and an outer channel section not being in direct contact with the thermoelectric element.

The heat pipe is made of copper or aluminum with a thickness of 0.5 mm or more.

The blower is positioned at a predetermined distance from the thermoelectric element, adjacent to the heat radiation fins.

In an another aspect of the present invention, a heat radiator for a cup holder may include a thermoelectric element mounted on the cup holder, a heat pipe with an one end fixed in a surface contact with a heat radiation side of the thermoelectric element mounted on a body of the cup holder and another end being extended from the one end at least above the one end, heat radiation fins fixed in a surface contact with another end of the heat pipe, and a blower engaged to the another end of the heat pipe so as to enable the heat radiation fins to exchange heat.

The body of the cup holder is made of a heat conductive metallic material and the thermoelectric element is disposed with an air-conditioning side in close contact with the body of the cup holder.

In another aspect, the present invention may include a cup holder, wherein a thermoelectric element is disposed on the side of the cup holder body and a heat pipe is extended to a side of a body of the cup holder and inclines upward from an one end to another end thereof such that the another end is positioned higher than the one end.

A thermoelectric element is disposed on the side of the cup holder body and a heat pipe is extended above the body of the cup holder.

The thermoelectric element is disposed on a bottom in the body of the cup holder and a heat pipe bends upward from one end and then is extended to another end such that the another end is positioned higher than the one end.

According to a heat radiator for the cup holder and the cup holder having the structures described above, it is possible to reduce the volume and weight of the heat radiation part.

The efficiency of the heat pipe is maximized and the heat of the thermoelectric element is sufficiently radiated, so the cooling/heating performance of the cup holder increases.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a heat pipe and heat radiation fins of a heat radiator for the cup holder according to an exemplary embodiment of the present invention.

FIGS. 2 to 3 are views showing the cup holder according to various exemplary embodiments of the present invention.

FIGS. 4 to 5 are views showing the cup holder according to various exemplary embodiments of the present invention.

FIGS. 6 to 7 are views showing the cup holder according to various exemplary embodiments of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Embodiments of the present invention are described hereafter with reference to the accompanying drawings.

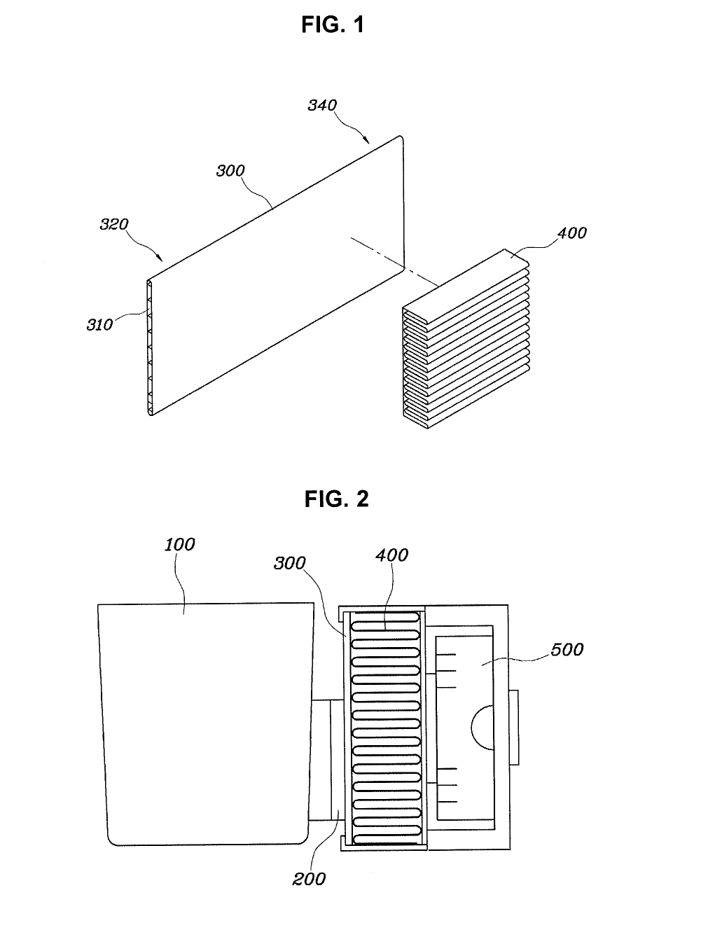

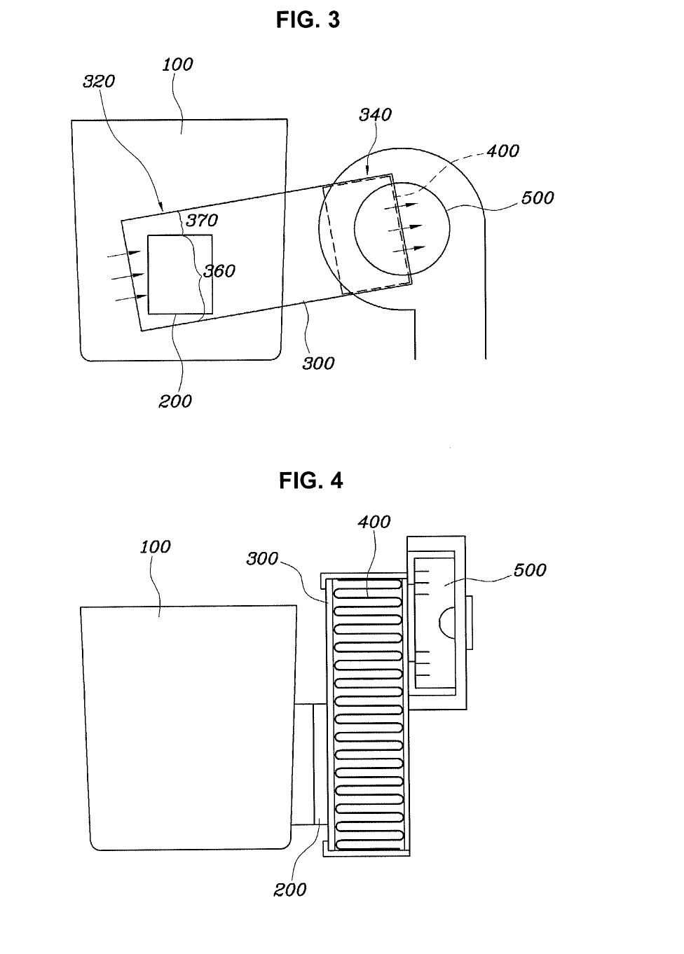

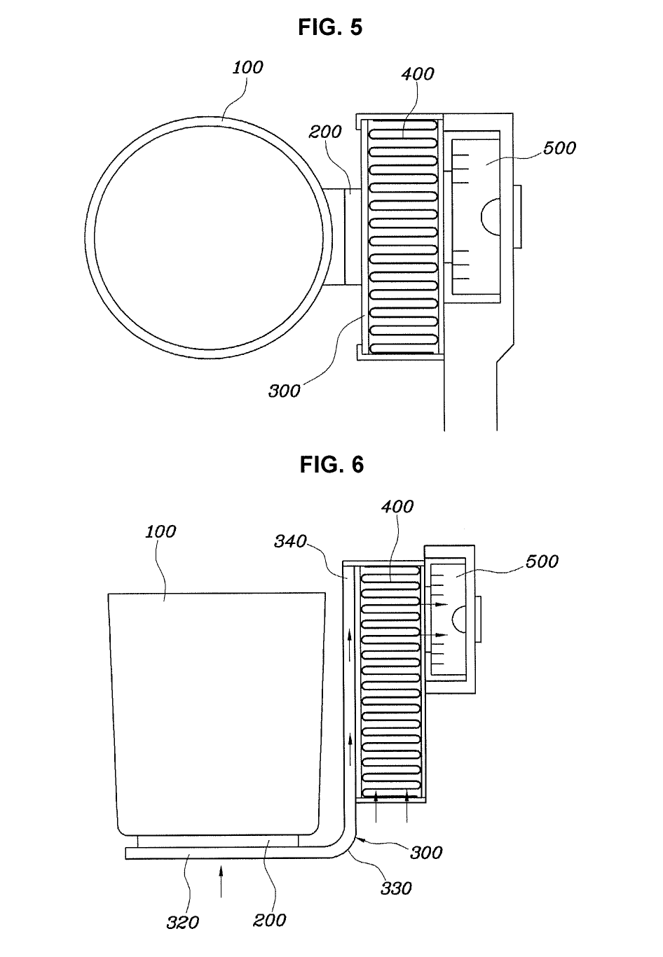

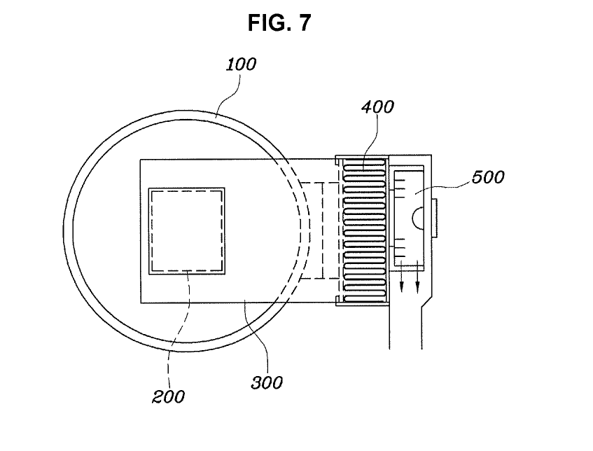

FIG. 1 is a view showing a heat pipe and heat radiation fins of a heat radiator for the cup holder according to an exemplary embodiment of the present invention, FIGS. 2 to 3 are views showing the cup holder according to a first embodiment of the present invention, FIGS. 4 to 5 are views showing the cup holder according to a second embodiment of the present invention, and FIGS. 6 to 7 are views showing the cup holder according to a third embodiment of the present invention.

A heat radiator for the cup holder according to an exemplary embodiment of the present invention includes: a heat pipe 300 with one end 320 fixed in surface contact with a heat radiation side of a thermoelectric element 200 mounted on the cup holder body 100 and another end 340 being extended from the one end 320 at least above the one end 320, heat radiation fins 400 fixed in surface contact with another end 340 of the heat pipe 300, and a blower 500 enabling the heat radiation fins 400 to exchange heat.

The heat pipe 300, a hollow copper pipe, has many small holes, so it has a space through which fluid can pass. The space is filled with volatile liquid. When heat is applied to a side of the pipe, the volatile liquid evaporates into a gas and the volatile liquid changed in a gas obtains thermal energy and moves to the opposite side. The gas radiates heat at another side of the pipe and the gas with the temperature decreased by radiating heat changes into liquid and returns to the previous side of the pipe through the space.

The present invention achieves a radiator for the cup holder by using the heat pipe 300 and is characterized in that the entire weight reduces and the efficiency of heat radiation is maximized because there is no need of a mass base for heat radiation.

In detail, the heat radiator for the cup holder according to an exemplary embodiment of the present invention includes: a heat pipe 300 with one end 320 fixed in surface contact with a heat radiation side of a thermoelectric element 200 mounted on the cup holder body 100 and another end 340 being extended from the one end 320 at least above the one end 320, heat radiation fins 400 fixed in surface contact with another end 340 of the heat pipe 300, and a blower 500 enabling the heat radiation fins 400 to exchange heat.

The cup holder body 100, which is made of heat conductive metallic material, holds a cup. A thermoelectric element 200 that cools or heats an object through an air-conditioning side and radiates or takes heat through a heat radiation side is mounted on the cup holder body 100. Obviously, the air-conditioning side of the thermoelectric element 200 faces the cup holder body 100.

The heat pipe 300 is fixed with one end 320 in surface contact with the heat radiation side of the thermoelectric element 200 mounted on the cup holder body 100. In this position, another end 340 is extended from the one end 320, above at least the one end 320. Accordingly, the heat of the thermoelectric element 200 is radiated at an ultrasonic speed through the heat pipe 300 and the cooling/heating efficiency of the thermoelectric element 200 is correspondingly increased.

In particular, the heat pipe 300 uses evaporation of fluid therein, so when the heat radiation side is higher, hot gas naturally moves up and cold liquid moves down, and thus the efficiency of the heat pipe keeps optimum.

Therefore, another end 340 of the heat pipe 300 is extended from the end 320 and is positioned at least above the one end 320.

Further, the heat radiation fins 400 are fixed in surface contact with another end 340 of the heat pipe 300 and the blower 500 is provided to enable the heat radiation fins 400 to exchange heat.

The heat pipe is coupled to the heat radiation fins in surface contact with them by soldering or heat conduction bonding, as shown in FIG. 1. The heat pipe 300 has the shape of a plate and may be closed in the vacuum state with a plurality of channels 310 horizontally arranged in parallel therein. Accordingly, each of the channels functions as a heat transfer path.

In particular, the heat radiation fins 400 are coupled to the heat pipe 300 such that the directions of the fins are the same as the direction of the channels to make heat flow most smoothly, and as shown in FIG. 2, one end 320 of the heat pipe 300 may be formed wider than the thermoelectric element 200 and composed of an inner channel section 360 being in direct contact with the thermoelectric element and an outer channel section 370 not being in direct contact with the thermoelectric element 200.

Accordingly, the inner channel section 360 can directly transfer heat and the external channel section 370 can transfer heat that is transmitted by diffusion. Therefore, higher heat transfer efficiency can be achieved.

On another hand, the heat pipe 300 may be made of copper or aluminum with a thickness of 0.5 mm or more and the blower 500 may be positioned at a predetermined distance or more from the thermoelectric element 200, close to the heat radiation fins 400. Accordingly, the thermoelectric element 200 can cool/heat an object without receiving an influence from the outside.

A heat radiator for the cup holder according to an exemplary embodiment of the present invention includes: a thermoelectric element 200 mounted on the cup holder body 100, a heat pipe 300 with one end 320 fixed in surface contact with a heat radiation side of a thermoelectric element 200 mounted on the cup holder body 100 and another end 340 being extended from the one end 320 at least above the one end 320, heat radiation fins 400 fixed in surface contact with another end 340 of the heat pipe 300, and a blower 500 enabling the heat radiation fins 400 to exchange heat.

The cup holder body 100 may be made of heat conductive metallic material and the thermoelectric element 200 may be disposed with the air-conditioning side in close contact with the cup holder body 100.

FIGS. 2 and 3 show a first embodiment of the present invention, in which the thermoelectric element 200 is disposed on the side of the cup holder body 100 and the heat pipe 300 is extended to the side of the cup holder body 100 and may be inclined upward from one end 320 to another end 340 such that another end 340 is positioned higher than the one end 320.

FIGS. 4 and 5 show a second embodiment of the present invention, in which a thermoelectric element 200 is disposed on the side of the cup holder body 100 and a heat pipe 300 may extend above the cup holder body 100, preferably vertically extend.

In FIGS. 6 and 7, a thermoelectric element 200 may be disposed on the bottom of the cup holder body 100 and a heat pipe 300 may bend upward from one end 320 and then is extended to another end 340 such that another end 340 is positioned higher than the one end 320.

According to the heat radiator for the cup holder and the cup holder having the structures described above, it is possible to reduce the volume and weight of the heat radiation part.

The efficiency of the heat pipe is maximized and the heat of the thermoelectric element is sufficiently radiated, so the cooling/heating performance of the cup holder increases.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heat radiator for a cup holder comprising:
a heat pipe with an one end fixed in a surface contact with a heat radiation side of a thermoelectric element mounted on a body of the cup holder and another end being extended from the one end at least above the one end;
heat radiation fins fixed in a surface contact with another end of the heat pipe; and
a blower engaged to the another end of the heat pipe so as to enable the heat radiation fins to exchange heat.

2. The heat radiator for the cup holder of claim 1, wherein the heat pipe and the heat radiation fins are coupled by soldering or heat conduction bonding.

3. The heat radiator for the cup holder of claim 1, wherein the heat pipe is in a shape of a plate and is closed under a vacuum state with a plurality of channels horizontally arranged in parallel therein.

4. The heat radiator for the cup holder of claim 3, wherein the heat radiation fins are coupled to the heat pipe to be aligned in a direction of the channels of the heat pipe.

5. The heat radiator for the cup holder of claim 1,
wherein an one end of the heat pipe is formed wider than the thermoelectric element and includes an inner channel section being in direct contact with the thermoelectric element and an outer channel section not being in direct contact with the thermoelectric element.

6. The heat radiator for the cup holder of claim 1, wherein the heat pipe is made of copper or aluminum with a thickness of 0.5 mm or more.

7. The heat radiator for the cup holder of claim 1, wherein the blower is positioned at a predetermined distance from the thermoelectric element, adjacent to the heat radiation fins.

8. A heat radiator for a cup holder comprising:
a thermoelectric element mounted on the cup holder;
a heat pipe with an one end fixed in a surface contact with a heat radiation side of the thermoelectric element mounted on a body of the cup holder and another end being extended from the one end at least above the one end;
heat radiation fins fixed in a surface contact with another end of the heat pipe; and
a blower engaged to the another end of the heat pipe so as to enable the heat radiation fins to exchange heat.

9. The heat radiator for the cup holder of claim 8, wherein the body of the cup holder is made of a heat conductive metallic material and the thermoelectric element is disposed with an air-conditioning side in close contact with the body of the cup holder.

10. The heat radiator for the cup holder of claim 8, wherein a thermoelectric element is disposed on the side of the cup holder body and a heat pipe is extended to a side of a body of the cup holder and inclines upward from an one end to another end thereof such that the another end is positioned higher than the one end.

11. The heat radiator for the cup holder of claim 8, wherein a thermoelectric element is disposed on the side of the cup holder body and a heat pipe is extended above the body of the cup holder.

12. The heat radiator for the cup holder of claim 8, wherein the thermoelectric element is disposed on a bottom in the body of the cup holder and a heat pipe bends upward from one end and then is extended to another end such that the another end is positioned higher than the one end.
